(19) United States
(12) Patent Application Publication
(10) Pub. No.: US 2018/0229372 A1
(43) Pub. Date: Aug. 16, 2018

(54) MAINTAINING ATTENTION AND CONVEYING BELIEVABILITY VIA EXPRESSION AND GOAL-DIRECTED BEHAVIOR WITH A SOCIAL ROBOT

(71) Applicant: JIBO, INC., Boston, MA (US)

(72) Inventors: Cynthia BREAZEAL, Cambridge, MA (US); Fardad FARIDI, Marlborough, MA (US); Sigurdur Orn ADALGEIRSSON, Somerville, MA (US); Samuel Lee SPAULDING, Wilmington, NC (US); Andrew Paul Burt STOUT, Cambridge, MA (US); Thomas James DONAHUE, Arlington, MA (US); Matthew R. BERLIN, Somerville, MA (US); Jesse V. GRAY, Somerville, MA (US)

(21) Appl. No.: 15/890,798

(22) Filed: Feb. 7, 2018

Related U.S. Application Data
(60) Provisional application No. 62/457,603, filed on Feb. 10, 2017.

(51) Int. Cl. B25J 11/00; B25J 9/16

(52) U.S. Cl. CPC B25J 11/001; B25J 9/163; B25J 11/0015

(57) ABSTRACT

A socio-emotive-cognitive architecture for a social robot that includes at least two of an attention system that determines at least one of the subject on which and the direction to which the robot focuses at least one of its resources in real-time; an embodied speech system that facilitates intent-based variation of utterances combined with multi-segment body movement; a motivation system that adjusts at least one of the degree of interaction and a mode of interaction for engaging a human user; and an emotion system that partially determines how the attention system, the embodied speech system, and the motivation system perform for any given interaction with a human.

### CROSS-REFERENCE TO RELATED APPLICATIONS

This application claims the benefit of priority of U.S. Provisional Patent Application No. 62/457,603, titled “MAINTAINING ATTENTION AND CONVEYING BELIEVABILITY VIA EXPRESSION AND GOAL-DIRECTED BEHAVIOR WITH A SOCIAL ROBOT,” filed on Feb. 10, 2017, which is hereby incorporated by reference in its entirety.

### BACKGROUND

The disclosed embodiments are directed toward robotics and, in particular, to systems and methods for operating a social robot.

A number of challenges exist for managing dialog between a social robot and a human. One of these is the difficulty in causing a robot to deliver expressions that convey emotion, tone, or expression in a way that seems authentic, believable and understandable, rather than what is commonly called “robotic.” By contrast, humans often convey speech together with non-language sounds, facial expressions, gestures, movements, and body postures that greatly increase expressiveness and improve the ability of other humans to understand and pay attention.

Another challenge lies in the difficulty in causing a robot to convey expression that is appropriate for the context of the robot, such as based on the content of a dialog, the emotional state of a human, the state of an activity performed between human and robot, an internal state of the robot (e.g., related to the hardware state or software/computational state), or the current state of the environment of the robot.

### SUMMARY

A social robot may be configured with capabilities to facilitate maintaining attention on high interaction value targets (e.g., humans) in its environment while interacting in a character-specific manner including goal-directed behavior, proactivity, spontaneity, character believability, emotive responses, and personalization. The social robot may, using various capabilities and components of a cognitive architecture, including, without limitation, capabilities and components for managing states (including emotional, cognitive and contextual states), anticipation of future states, management of attention, pursuit of goals and objectives, delivery of embodied speech, and execution of various context-specific skills and roles. The social robot may maintain and access a distributed knowledge base that informs anticipation, decision-making, cognition, emotional response, and other capabilities of the social robot.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 is a functional block diagram illustrating a device output control architecture according to some embodiments of the disclosure.

FIG. 2 is a functional block diagram illustrating an attention system of the social robot according to some embodiments of the disclosure.

FIG. 3 depicts is a functional block diagram illustrating an attention system of the social robot according to some embodiments of the disclosure.

FIG. 4, is a flow diagram illustrating a method for skill execution according to some embodiments of the disclosure.

FIG. 5, is a block diagram illustrating an MB category skill according to some embodiments of the disclosure.

FIG. 6 is a block diagram illustrating a Mystery Box skill according to some embodiments of the disclosure.

FIG. 7 is a diagram illustrating proactive behaviors according to some embodiments of the disclosure.

### DETAILED DESCRIPTION

### Socio-Emotive-Cognitive Architecture Made Up of Various Robot Control Systems

A social robot that interacts with humans as a unique character may interact via a range of expressions that are delivered through speech, various paralinguistic phrases, coordinated multi-segment body movement, transformative imagery coordinated with speech and movement while being aware and reactive to people and objects in its vicinity. Such a social robot may be controlled via a socio-emotive-cognitive architecture (which alternatively may be referred to in some cases as a “psychological-social-cognitive architecture, or the like) that may facilitate determining a subject on which the social robot focuses its resources, including, without limitation, in a goal-directed manner by considering factors such as what the social robot is currently paying attention to, what motivations are currently affecting the robot, what task goals the robot is working to achieve, and how emotional factors of the robot's current situation impact interactions or behavior, among other factors.

Further, the robot, through coordination of social, cognitive, motivational and emotive capabilities, among others, may exhibit believable behavior to people observing or interacting directly with the robot. Believable behavior may encompass various capabilities that might normally be ascribed to intelligent, thinking beings; for example, believable behavior may include that the robot's observable actions convey intentionality in that they arise from the robot's social, emotional, motivational, and cognitive (including knowledge, decision making, attentional, perceptual, etc.) states. Such states may be computed by various elements of the social robot's socio-emotive-cognitive architecture. For instance, the intentionality of the robot may be conveyed to an observer via the robot's cognitive/thinking states paired or coordinated with the robot's emotive reactions to those cognitive states (e.g., affective appraisals). Based on this intent, the robot may perform an action that may change the state of the robot system and potentially its relation to the external world. The robot then reacts to this change of state, conveying subsequent thought (e.g., expectation, violation of expectation, progressing toward the goal, achieving the goal, etc.) paired with an appropriate emotive response. Through a series of transitions of states (cognitive/thinking and emotional/affective), the robot may convey realistic, reactive behavior. States may be determined based on inputs from various systems (e.g., sensory systems, programmatic inputs, inputs from the social robot's knowledge base, and the like) and may provide inputs to the various systems and components of the social robot (including inputs for determination of other states and inputs for attention, emotion, cognition and motivation, among others). The reactions of a social robot may be tuned, such as varying the behavior to reflect the individual, personalized character of the social robot; thus, a developer, using the development platform of the social robot, may develop a character by modulating the social robot's reactions (cognitive/thinking and emotive/affective, among others) when embodying or experiencing a given state.

Consider the following scenario: upon the robot hearing its name called, the robot becomes more aroused and conveys interest. The robot acts to engage the person by turning its body toward the sound source (via sound localization algorithms to set the target of its attention system) to face the person. Once the orientation movement is performed, the robot expects to see the person's face with its cameras and uses face detection algorithms to confirm a face is present. If the person is not there, the robot's goal of finding a face is not achieved. Thus, the robot's expectation is violated resulting in an internal affective state of surprise that is accompanied by the associated expression. The goal persists, however, so the robot continues to act in a goal driven manner to find a face and begins to visually search for one by making the next orientation movement to the next most likely target location. If the robot then sees a person on the next try, its goal is achieved, a positive emotive state results from success, and the robot expresses pleasure. Seeing the face gives rise to a behavior to engage the person and an internal affective state of interest results with an accompanying expression of openness to interaction for what the person might say or do next.

Note that this goal achieving behavior is different from pure transactional skills. A transactional skill follows a more basic command-response behavior that is executed in an open-loop fashion. For instance, setting a timer could be implemented as a transactional skill if the robot simply counts down to time equals zero and sounds an alarm regardless of who is around to hear it or not. A goal-directed version of a timer skill would be where the robot has the goal of making sure the person who set the timer knows that time is up. In this case, if the timer goes off and the person is not around to hear it, the robot may pursue other behaviors—such as calling the person's cell phone to make sure they are aware that time is up. In a goal directed behavior, the robot persists toward the goal until it is achieved, trying different things until success or potentially a condition whereby it gives up or tries again later. As another example, a transactional version of a robot photographer skill would be a voice-activated camera where a person commands the robot to take a picture and the robot does so regardless of any goal to take a good picture. In contrast, a goal-directed robot photographer might be comprised of a set of goals and behaviors that collectively define what a good picture is (e.g., make sure the camera is pointed on the intended subject, making sure the subject is not backlit, etc.) and to act to bring about the contexts where a good picture can be captured. Note that a socio-emotive-cognitive architecture can perform both transactional skills as well as goal-directed skills.

In accordance with exemplary and non-limiting embodiments, the social robot may include a multi-modal attention system that determines a subject on which the social robot focuses its resources (perceptual, performance outputs, goals, etc.) in real-time or near real-time. The attention system can then direct the robot's body to orient toward that target in a goal-directed, context-relevant way, and track the target if appropriate.

The social robot may further include an embodied speech system that facilitates intent-based variations of spoken utterances and other paralinguistic non-verbal or non-spoken communications, optionally combined with multi-segment body movement of the social robot, graphical display, sounds, lighting effects, etc.

The social robot may further include a motivation system, by which various motivations, homeostatic goals, long-term intents, or the like may be managed for the social robot. In embodiments, the motivation system may adjust a degree of interaction taken to engage a human who is proximal to the robot, such as based on types and amounts of recent interactions.

The social robot may further include an emotion system for managing emotions and other affective states that are embodied and expressed by the social robot. In embodiments, the emotion system may at least partially determine how the attention system, the embodied speech system, task-oriented behaviors, and the motivation system perform for any given interaction with a human. The emotion system can also be influenced by these same factors. The emotion system works with the expressive multi-modal systems of the robot to convey the accompanying expressive states that go along with attentional, emotive, affective, and other cognitive states to convey believable behavior.

The social robot may further include a skills performance system that works cooperatively with one or more of the attention system, the embodied speech system, the motivation system, and the emotion system to generate an instance-specific version of a skill to control the robot's performance of a skill or goal-directed task. The attention system, embodied speech system, motivation system and emotion system may be combined in a social robot socio-emotive-cognitive architecture that facilitates control of the social robot to pursue and achieve task goals in a believable manner, as well as to execute purely transactional tasks.

The motor system of the robot can arbitrate among these various sources of body orientation and expression modalities to deliver a believable multi-modal coherent, time-orchestrated performance comprised of body animation, graphics, speech, sound and LED performance that conveys intention, emotional tone and personality.

### Socio-Emotive-Cognitive Architecture Made Up of Interrelated Data Processing Layers—Physical Interface Layer

In accordance with an exemplary and non-limiting embodiment, a socio-emotive-cognitive architecture of a social robot may include a physical interface layer that manages inputs received by the robot via, for example, sound, visual, inertial, motion, and tactile sensors of the social robot and outputs of the social robot via, for example, audio, electronic display, lighting, and movement (including multi-segment body movement) or overall motion (e.g., being picked up and carried). Exemplary input sources include, but are not limited to, cameras (including depth cameras, including stereoscopic and 3D camera arrays), audio (including localized and/or far field audio), speech (such as for automated speech recognition), motion or depth sensors (such as from camera-based phase recognition and motion detection, laser-based motion detection, and others), and identification sources (such as sources used for code-based recognition, biomarkers, facial recognition, voice recognition, and the like), capacitive touch sensors on the body or a touch screen for tactile inputs, or accelerometers and gyros to sense the motion of the robot. Exemplary outputs include speech (including generated from text-to-speech systems), semi-speech utterances, electronic displays, animations, video, lighting effects, physical movements, gestures, and many others. Further outputs may include procedural movements, with or without animation. For example, the social robot may be instructed to position itself to face along a specific vector without any accompanying graphical or movement animation. In other embodiments, target-directed movement and expressive movement may be coordinated with graphical animation appearing as screen content. In yet other embodiments, outputs may include audio, including paralinguistic or semi-speech audio, such as sounds that convey information or emotion without consisting of full words. Many other embodiments of physical layer systems and components are contained throughout this disclosure and the documents incorporated herein by reference.

### Intentional Layer for Believable Behavior

The socio-emotive-cognitive architecture may further include an optionally goal-directed intentional layer for conveying believable behavior that abstracts content received via various inputs including perceptual information from the environment, data from other connected devices, data or state information from task-oriented skills, knowledge (such as personalization information, task knowledge, online information sources), mechanisms to direct attentional states, dialogic states, affective information (such as data from emotive states or motivational states) to facilitate recognition, context awareness, state estimation, and the like to the extent necessary to provide a context-appropriate actionable understanding of the situation of the social robot, so that an appropriate behavior can be determined for the social robot. The behavior layer may provide a stream of content, such as commands and data, for controlling at least a portion of the outputs to support executing actions and pursuing goal-directed behavior. These behaviors may correspond to specific skills that require playing a defined role in a workflow (many of which are described throughout this disclosure)—or may reflect more generalized behaviors, such turning toward or visually searching for a person of interest, paying attention to a subject, proactive behaviors such as greetings, engaging in endearing and playful interactions intended to surprise and delight and, engaging in interactions to help the robot learn about people and activities.

The point is that the robot can behave in an intentional way to help people achieve tasks from relatively simple and transactional (e.g., setting a timer), to goal-directed tasks (e.g., taking a good photograph), to more sustained and complex objectives comprised of multiple goals and tasks (e.g., educate the person to learn a second language). In sum, this layer includes computational mechanisms and representations to perform a wide repertoire of socio-emotive-cognitive functions pertaining to believable and intelligent, goal directed, environmentally appropriate, adaptive abilities including but not limited to: natural language understanding, multi-modal conversation and communication, perceptual understanding, planning, reasoning, memory and knowledge acquisition, task based knowledge and skills, attention, emotion, motivation that all support the social robot interacting with people as an intentional, self-motivated, intelligent, emotionally responsive character. Each of these aspects of such an intentional layer, and the various systems and components used to enable them in the architecture of the social robot, may be made available to a developer, such that the developer may use them, coordinate them, module them, and manage them to cause the social robot to convey a desired, believable behavior, such as one that is appropriate for a given context, task, role, or skill.

Using development tools, a developer may develop a wide range of behaviors (from transactional to intentional and believable) for a social robot, each consisting of a series of outputs that embody the behavior, including content, expressions, movements, and the like.

For instance, a goal-directed behavior may be for the robot to maintain a certain perceptuo-motor relationship to its environment (e.g., such as visually tracking a target during a video call), or establishing and maintaining the robot's orientation to face the person calling its name or speaking to it (as illustrated above).

Goals can be more complex for more sophisticated tasks, which may be comprised of multiple goals that require sequencing or planning of actions and behaviors. For instance, let's revisit the example of a goal-directed photographer skill where the goal is to take a good photograph, where “good” is specified as adhering to certain conditions such pointing the camera to have the subject centered in the field of view, keeping the subject centered in the field of view if the subject is moving, avoiding the subject being backlit (e.g., asking the subject to move to a different location with better lighting), avoiding taking a picture where the subject closing his or her eyes by performing machine vision classification on eye-region data, etc.).

Goals or motives can be robot-initiated and result in proactive behaviors. An example is the robot having a social drive/motive that is satiated by interacting with a person every day. To satiate the social drive, for instance, the robot could have a self-initiated goal of interacting with each person in its household at least once per day. This robot-initiated goal could be achieved through a proactive greeting behavior whereby the robot tries to recognize each person to give them a personalized greeting with an invitation to interact in some deeper way (e.g., by offering curated content or activities of known interest to the individual). The robot may learn over time that specific people are most receptive to the robot's attempt to engage via personalized greetings at different times of day (e.g., when first waking up, when first arriving home from work or school, when winding down for bed, etc.). Thus, the robot may use machine learning to adapt and personalize this proactive greeting behavior accordingly—e.g., for someone who is most likely to interact with the robot when he or she first wakes up, the robot could adapt a proactive morning greeting behavior with an associated personalized morning report (e.g., weather, news, commute, sports, etc.)

More advanced combinations of intentional behaviors could involve helping a child learn knowledge or skills (such as learning vocabulary), helping a person to remember to take medication on a schedule, serving as a personal coach to help a person manage a chronic health condition, etc.

In some embodiments, the operations of the intentional layer may include natural language understanding (NLU) utilized to convert spoken word information into symbolic and semantic machine-understandable data. Embodied speech mechanisms are also supported in the intentional layer. In accordance with exemplary and non-limiting embodiments, there is disclosed a method of performing multi-node tagging of detected human speech by a social robot that is interacting with the human. First, embodied speech markup language content may be generated from an audio and video capture of a human speaking by generating a plurality of markup versions of the captured content. A first version of the content is marked up based on determined punctuation/audio emphasis in the captured speech. A second version of the content is marked up based on theme-rheme gaze behavior determined in the captured speech. A third version of the content is marked up based on a training set of content markup determined to be like the captured speech. The three versions of the content may be processed to generate a single marked up content based on automatic markup rules that address potential conflicts among the three versions for use by the social robot. The resulting single marked up content may be processed further to produce randomized variations of the captured speech that enable differentiated expression of the detected human speech.

High-level functions managed in the intentional layer may include, for example, learning to recognize people (e.g., facial recognition or voice identification) whereby the robot may have the goal of acquiring robust and accurate recognition models for each person in a household and associating those recognition models with the corresponding name. The robot could have the goal of not calling a person by the wrong name, and therefore may engage in a goal directed behavior to collect training data of each person and to gather statistics on recognition performance in other activities to verify the ID recognition models are robust before the robot begins to try to address individuals by name. If the robot does make a mistake and calls a person by the wrong game, the goal of not doing this could result in an apology response and soliciting more explicit help from that misidentified individual in collecting additional training samples to improve the model.

### Exemplary Outputs Include Language Generation, Embodied Speech, and the Like.

The intentional layer may also incorporate a multi-modal attention system. In accordance with exemplary and non-limiting embodiments, the social robot may be controlled to provide attention to people or things in the social robot's environment. In a mixed visual-auditory-touch based environment, there could be a number of events or entities that should be the focus of the robot's attention based on task, environmental state, robot's emotions, motivations, goals and the like. The result of determining the entity to attend to, the robot can compute the target and the motion trajectory to orient to face that target. For example, the social robot may calculate a direction vector and an approximate distance relative to the position of the social robot toward which the robot should orient its sensors and prioritizes content capture.

A saliency map may encompass a computational representation that highlights entities in a spatial environment that are candidate targets for the robot's attention. Higher intensity regions in the saliency map correspond to regions of higher interest and relevance to the current context. Bottom-up (environmental and perceptual) and top-down (goal, or motive based) factors can bias the robot's attention. The context to which the attention system must respond includes the environment, active task(s), social interactions, emotional states, motivational states, etc. In the case of bottom-up stimuli that impact saliency (e.g., motion, color, proximity, face detection, speech, etc.), the social robot may then proceed to adapt its behavior based on a saliency map that is derived from visual images of the environment, audio captured by the social robot and organized into directional audio beams, tactile input, semantic properties of captured human spoken audio.

In some embodiments, the saliency map may be adjusted in real time for each sensed environment change that exceeds a novelty threshold. In other embodiments, the impact of a duration of time of an instance on the saliency map may be adjusted by applying a habituation/decay of relevance algorithm. In some embodiments, lower level perceptual inputs can be given higher weight to become more salient in relation to others based on task or social context. For instance, the social motive can bias the robot to interact with people and influence the saliency map to weight face-like stimuli stronger to bias the robot to attend to faces. In a photography based task, the face detector can highlight regions in the robot's saliency map so that the robot is most likely to point its camera at people rather than other parts of the environment that may also be salient (e.g., a loud sound source, a motions source like a fan, etc.). However, a person could potentially attract the robot's camera to non-face stimuli by creating a highly salient competing stimuli (e.g., large motion stimulus that wins out, such as by waving their hand vigorously can calling “over here”). In this way, the robot's attention is context-relevant based on saliency attributes that can be adjusted based on the goal of the task and the intent of people interacting with the robot.

In accordance with exemplary and non-limiting embodiments, there is disclosed an attention system visualizer comprising a user interface overlaid on a depiction of the social robot captured video, audio, and tactile inputs that depicts a saliency map as it adjusts over time.

There are many different possible logics for how an attention system processes the surrounding context to decide exactly how to move its output modalities in response. Some logics may be designed to promote natural, lively behavior. Other logics may be designed to make tasks with the robot more efficient and less distractible when in a task. Accordingly, how the robot glances, animates, orients can vary depending on the objective. This includes different visual behaviors such as fast animated eye movements that emulate human saccades, smooth pursuit eye and body movements to track a person while keeping the camera moving as smoothly as possible—or more character-rich orientation movements where first the eye looks to the target, followed by the head, and then the body followed by restoring movements whereby the robot returns to a neutral body pose but now facing a new direction. In some embodiments, the social robot may remain physically nearly motionless while moving the displayed eye. After enough eye deflection, the social robot may turn its body so that the face is pointing at the motion. As the social robot may be aware of the uncertainty of sensory elements, it may not commit to a new center of gravity until information or input in that direction persists. In other embodiments, for example if the social robot sees a face, it may engage temporarily, but disengage and come back to check again at the same place later. This may avoid the sense of a user that the robot is “staring” in an awkward manner.

In some embodiments, there may be determined where the social robot is looking at a given time and what area of space the social robot cares about at a given time. In some instances, it may take a multitude of inputs and context points to decide where to pay attention. In some instances, a skill may be responsible for controlling the social robot's behavior including controlling where the social robot should look and to whom it should pay attention. In other embodiments, a skill merely focuses on what that skill is for and doesn't require micromanaging the social robot with regards to where it should look, how it should respond to sounds, etc.

In some embodiments, various and different context inputs may be used to evaluate and identify the attributes of a situation. In some embodiments, a local perceptual system (LPS) is utilized to receive inputs. The LPS system may function as a higher-level perceptual system that integrates lower level sensory inputs into a persistent map of environmental stimuli around the robot. The LPS may manage localized audio, visual features like detected visual motion, detected human faces (recognized faces with ID) and compile that into “perceptual tracks” of humans.

For example, the LPS may determine how loud a sound needs to be before the social robot takes notice and action based thereupon. Sound and sound localization may be determined via, for example, audio cones around the social robot. In some instances, audio resolution may vary in a spatial manner. For example, there may be higher audio spatial resolution in front of the social robot than behind it. In some embodiments, the social robot may orient itself to the origin of a sound and go into active listening mode when, for example, it detects the utterance of a pre-programmed hot phrase (or command phrase), such as “Hey, buddy”. In addition to audio detection, the social robot may rely on motion detection, facial detection/recognition and phrase identification for purposes of orientation.

In some embodiments, the social robot is tasked with paying attention to an area or general direction around 360 degrees of rotation. In such instances, the social robot may have a specific area of interest. The determination of which area is of interest may be based on several factors. For example, if someone says “Hey buddy, tell me the recipe for X”, the social robot's confidence in the direction of that voice becomes higher as the social robot expects the speaker to be there. In some instances, the social robot may gravitate towards places where he believes people are more likely to appear. Then, if the social robot senses low volume sounds, it may glance with a displayed eye. If the sounds are higher volume or persist in time, the social robot might orient its body that direction. If interesting enough, the social robot might commit the social center of gravity to the origin of the sound. As described, the social robot is constantly trying to figure out where it should be orienting, based on a collection of sensory inputs in all directions around the robot, as well as based on anticipating activities (such as based on past interactions, e.g., the arrival of the family every morning at the breakfast table at a given time). Generally, the social robot continually looks for a social center, tracks it, and makes movements to improve data gathering.

In some embodiments, absent substantive or new sensory inputs, the social robot may act on a “boredom” model. In accordance with such a model, if nothing happens for a certain amount of time, the social robot might choose an area to explore for a few minutes. It might slowly move its sensors to collect sound and activity about the environment. In such a mode, sensitivity to sound and visual activity may be enhanced so that the attention system may direct the social robot resources to such sensed activity or differences in the environment. By moving its sensors (e.g., by rotating one or more of its body segments), widening a range of audio detection, and the like, the attention and LPS systems of the social robot may notice something that otherwise might not get noticed.

In other embodiments, the attention system employs a character system that is constantly running and applying output always independent of whether a skill is running. In an “idle” mode, the attention system may be active, so the social robot can be directed by the attention system to look around the environment at interesting things. When the social robot switches into an interaction skill, the attention system may sustain the robot's orientation to the human target of the interaction and listen in an engaged manner.

When a launch grammar or a hot phrase is detected, the attention system may exit “idle mode” and go into “skill mode” or “interactive mode.” At such point, the social robot is engaged and fully interacting with the user, so it is much less distractible by other competing activity, sounds, or the like that are detectable in its proximity. The thresholds needed for the social robot to look around for other people or activity to pay attention to may subsequently be much higher. In such instances, the social robot may mimic what happens if people are interacting with each other, i.e., the social robot might glance around at a noise, then come back to the primary focus of the attention system. Essentially, when in the “interaction mode” the social robot may be less likely to react to stimuli unrelated to the primary focus of the attention system. The social robot may continue to maintain the best estimate as to where the primary attention system target person is. If the person is moving, the social robot may try to track them and adjust the orientation of the robot's sensors to attempt to keep them centered on the person. In some embodiments, the system may focus on tracking the person and keeping the social robot focused on that person with a heavily filtered approach that mitigates the degree and propensity of the robot to react to sensed activity that is outside of the updated/estimated location of the person. The goal is so that the robot does not appear to be too twitchy, such as by looking every which way when hearing a noise, detecting movement, attempting to recognize a face, or the like, such as detecting a false positive facial recognition.

When the execution of skill appears to be over, the social robot may go back to the idle mode. In such a mode, the social robot may be oriented towards the person who remains there, but the social robot may tend to stay focused in this area while reducing thresholds and activating the idle mode activity of looking around, etc. An attentional engagement policy can be defined that for what orientation actions may be taken in response to stimuli while in an idle mode. Policy examples are as follows:

1. IDLE: If the social robot hears low volume sounds that are transient, it will just turn is eye to indicate awareness but not full attention to the stimulus.
2. IDLE: If the social robot hears high volume or persistent low volume sounds above threshold, the social robot will move his eye then head in that direction to determine if the social robot should fully orient to the stimulus. If not sufficiently salient, the robot returns to its original behavior. If salient but low, the social robot may dwell, looking in a non-committal way for a time, before returning to its original behavior.
3. IDLE: Motion will track with eye at first, but if it makes it move too far enough to the side of the screen, the social robot will turn its head to try to keep looking at the thing that is interesting but doing so with its eye preferably centered on the screen.
4. IDLE: Perceptual data does not generally cause the social robot to commit a lot of energy to orienting and tracking them unless they have greater confidence.
5. IDLE: If a person does not engage, the social robot will glance to acknowledge and then turn back to previous state since the person is not sufficiently attention grabbing for full orientation and attention. The social robot may make note of him and his movement.
6. IDLE: If nothing happens for a while, the social robot may have an internal motive to explore by moving his body around looking for something of interest/salient. This might result in detection of salient sounds or people.

As described above, the social robot may assume various body poses as it conveys different levels of interest, attention, and awareness. The social robot is adapted to stay oriented toward a direction with several types of body poses. In some instances, the social robot may orient towards you, but lean toward the right or left (as if to cock its head to the side). If the social robot can strike different poses, it makes him seem like more of an active listener or speaker.

If the social robot is in a cameraman mode, it may move in a manner that does not jar the video it is capturing. The social robot provides the ability to control for expressiveness, while exhibiting other modes where the movement is more robotic and deadpan, but much better for capturing quality video. At the end of the interaction, when the skill is over, control goes may return to the idle mode and the attention system may regain full control.

The social robot may provide a consistent and coherent character feel across a variety of different modes. In one exemplary embodiment, a dialogue-based skill may have an “interaction mode” in which the social robot wants to stay very focused on a person. Other modes may exist for other skills. For example, regarding a skill that is more ambient and long-term, like a music skill, a user may say “Hey buddy, Play me some Jazz”. In response, the social robot may orient to the user and say “no problem”. At such time, the social robot might be almost in his idle mode wherein it is not interacting, but is engaged with that user.

In some embodiments, the social robot may identify a social center of gravity over a longer time-scale. The robot may learn regions where people frequently appear (e.g., doorways, dining table, etc.) and others where people never appear (e.g., behind the robot if it is on a countertop with a backsplash). For example, when the social robot is placed on a table and determines both that it has been moved in is in a stable position, the social robot may start mapping its environment. As the social robot observes people moving through the 3D space around it and senses motion, etc., the social robot may plot onto a 2D cylindrical surface the areas that have social relevance. In some instances, the social robot may observe that in a certain direction in a room are windows with lighting changes and motion triggers from the windows, but no social interactions. In other instances, an observed environment might have perceived perceptual relevance but no notable social relevance. For example, facing the kitchen or an entrance to a bedroom, the social robot may observe abrupt motion and people might sometimes engage. The TV might make noises and be visually interesting, but might not provide the opportunity for social interactions. Some environments might provide social relevance for a few hours. In some instances, the social robot may remember the history of an environment and know areas from whence people tend to approach. This knowledge can help the attentional policy of the social robot adapt to the environment and become better over time.

In some exemplary embodiments, the social robot may access general visual object classification information, such as via cloud services that detect general objects based on feeding images to the cloud. Utilizing such a resource, the social robot may know something is a television set, a desk chair, or a microwave oven and may allocate such identified objects into a map of relevance.

Once an object is identified, the social robot may make verbal reference to it such as by asking “Is there anything good on the TV?” or “I'm afraid of the microwave . . . . What are you cooking?” Knowledge of objects in the environment allows the social robot to work such things into the conversation. In yet other embodiments, the social robot may incorporate outside contextual data for use by the attention system. Such outside contextual data may include mapped inputs of the world and scheduled Content, such as TV schedules.

### Socio-Relational Layer

The socio-emotive-cognitive architecture may further include a higher order socio-relational layer that interacts with the goal-directed behavior and physical interface layers to undertake socio-relational processing and learning of information managed by those lower-level layers for learning about and interacting with people in more sophisticated, longitudinal ways. In accordance with exemplary non-limiting embodiments, the socio-emotive-cognitive architecture may further include socio-relational skills components for executing a plurality of specific skills that each interface with at least one of the intentional layer and the socio-relational layer. The robot's accumulated knowledge, learnings and short or long term memory can be a shared resource from which these skills can utilize for contextually relevant information. These include computational mechanisms for learning about people, groups, their relationships and their associated patterns of behaviors and preferences so that the social robot can be well adapted to the individual or the group over both short and long-term timescales.

Upon activation, the social robot may interact with a variety of human user types, such as reflecting different personalities, ages, languages, or the like. For example, the social robot may encounter a user who is excited about the social robot being chatty and proactive. Such a user may prefer the social robot to be proactive and lively and may not be troubled by the social robot making mistakes or being proactive and frequent in communication. In another instance, the social robot may encounter a user who wants the social robot to be mainly quiet, likes the social robot to anticipate things the user is interested in, but doesn't want much proactive behavior. In yet another embodiment, the social robot may encounter a child who wants the social robot to be doing something all the time. In some embodiments, the social robot may exhibit a different style or even character personality based on interacting with these different types. The robot's character may thus include, among other facets, a degree of interaction, including a typical frequency, style, volume and type of communication, among other things. Character can also include a wide range of other attributes, such as reflecting traits of human personality (e.g., introversion/extraversion, emotionality, intuition, and the like), motivations (such as interests in defined topics, goals, and the like), values (including ones embodied in rules or guidelines), and many others.

The social robot may act as an agent that addresses expectations from people to be autonomous in both action and in learning. In some embodiments, character customization may be driven from the social robot's models for behavior rather than by having a user adjust a specific aspect to meet their preferences.

A robot's interactions with a human may evolve over time, such as based on acquiring more and more information about the human. Some interactions may aid with basic processing of information by the social robot. For example, with regards to automated speech recognition (ASR), as the social robot learns regional accents, a speech impediment, and the like, the information gathered may enable the social robot to do an increasingly effective job of translating audio into text. The robot may learn mannerisms, such as specific greetings, and begin to use them. Translating audio to text is typically a low-level machine learning problem involving, for example, language, gender, age, accent, speech impediments and the like. Machine learning typically requires feedback as might be gathered from pre-classified users, perhaps conforming to each of the categories described above. Once gathered, the data may be used to update models offline. Similar effects may be had with other sensory systems, such as processing facial inputs for recognition of emotions. Thus, the robot's behavioral and socio-emotive-cognitive layers may have increasing confidence about inputs as familiarity with the human increases. Increasing confidence may in turn enable higher level skills, such as increasingly sophisticated dialog, that would not be possible when confidence levels about inputs are relatively low.

In other learning and adaptation paradigms, data collected over a population of robots could be shared (via the cloud) and used to improve the performance of socio-emotive-cognitive capacities so a population of robots can benefit from the accumulated experience of other robots to improve the performance of all of them.

### Personalization to Individuals

Over time, the social robot can make better assessments of the user, which may, in embodiments, allow the social robot to re-classify a user, such as based on learning more about the human. In some embodiments, the social robot may update models in real or near real time to reflect new information (which may involve changes in the human, such as the human becoming more and more comfortable with the robot). New knowledge about the person can be used to improve models that drive personalization and adaptation of the social robot to the user with respect to skills, style, and general “livability”—how proactive to be, what hours of the day to be active, how chatty, etc. As the social robot continues to classify a user, the social robot may, over time, adapt and otherwise improve the classification of the user with whom the social robot is interacting.

For example, as the social robot develops a high confidence in his interactions with an individual user, the social robot may change its behavior to reflect the preferences of the user as reflected in past interactions. For example, over time, as a social robot becomes more attuned to the individual personality of a user, the social robot may tell more jokes, including ones that are of the type that has amused the user in the past. The social robot may vary the frequency and the subject matter of such jokes based, for example, upon the amount of laughter or smiling elicited by previously communicated jokes.

In embodiments, when the social robot is friendly or familiar with a person of a type and seeks to interact with a person/user of a potentially different type, the social robot may create a basic matrix of type and familiarity, i.e., a relationship matrix. Such a matrix may be delineated, at least in part, by cells associated with discrete time extents. For example, the relationship matrix may have cells associated with early introduction (e.g., for a first month, or after only a small number of interactions), friends (e.g., for a second month, or through more interactions) and friends for life (e.g., from a third month on, or after an extensive number of interactions), and the like, wherein each cell of the relationship matrix corresponds to a preconfigured state for the social robot's socio-emotive-cognitive and character control system for type of relationship.

The intentional and socio-relational layers of the robot can thus be configured such that the robot's character emerges over time and is attuned at any given time to the extent of relationship with a person with which the robot is interacting, reflecting the increasing degree of relationship the robot has with a human over time. Thus, the robot may exhibit basic character traits with a stranger, somewhat more advanced traits with a casual acquaintance (as determined by a time or extent of past interaction) and fully embodied character traits with a close friend (after extensive interaction).

### Social Interaction Framework and Learning/Adaptation to Individuals

In accordance with an exemplary and non-limiting embodiment, the social robot may employ a type classification-based self-learning approach to adapting the social robot interactions. In some embodiments, social robot socio-emotive-cognitive architecture elements may be configured over time to classify each human with whom the social robot interacts into one of a plurality of personality types that are adapted through interaction-based learning by the social robot or by a plurality of social robots interacting with humans of each type that share their interaction data and/or learning therefrom.

For example, the social robot may classify users into categories, so that the social robot may, over time, based on a probability distribution, decide what that personality type wants, such as a degree of interaction, a type of information, a type of skill, a behavior, or the like. Thresholds for various aspects of the robot's architecture might be different for different types of people.

For example, with respect to the motivation system, type classification might be used as a basis for how quickly the social robot would undertake a greeting or generally be proactive in the information it provides. If a motivation to greet new people is turned way down, the social robot may rarely greet someone and, if tuned way up, the social robot may be very proactive at greeting and interacting with new people. A given tuning may be selected based on a determination of type. For example, a robot may classify a person as being an extraverted type by determining a frequency or volume of speech, specific speech content, the presence of laughter, or the like, in which case a more proactive tuning may be selected, with thresholds for greeting being easily met. In embodiments, the social robot may constantly classify people into, for example, archetypes, such as the ones discussed above and may proactively tune various parameters for greeting, for speech frequency, for animation, for movement, for expression of emotion, for attention, and many other factors.

In general, the proactive parameters of motivational system can be configured or learned via experience and interaction, as when, how frequently the robot should initiate interactions with individuals. This may be in the context of offering information—e.g., altering a person proactively or waiting until asked. It could also pertain to the ambient level of activity in the “sleep-wake” cycle of the robot. How often or when during the day/night the robot should be “asleep” or awake and attending to people, looking around. To be livable, the robot will need to tune this general behavioral pattern to the daily rhythm and preferences of the people the robot “lives” with.

### Social Matrix Interaction Framework and Learning/Adaptation to a Group

In addition to tailoring behavior on a user basis, the social robot may likewise tailor its behavior based, at least in part, on the attributes of more than one user such as may be found in a household. For example, a social robot's behavior may be customized to a set of people in a household, versus another household. This localized, group customization allows each robot to adjust its character and interactions differently for different households. Additionally, interactions among humans in different households may exhibit unique characteristics that do not translate well from one household to another. This may occur automatically over time based on machine learning and feedback. However, not all robot customization must be done automatically over time based on learning and repeated interactions. In some embodiments, a user or users may turn off or otherwise alter characteristics of the social robot off via settings or apps. Thus, the behavior of a social robot may be overridden, or dictated by specific commands. For example, a person may want the robot to be quiet during a phone call, which may be initiated by a command, after which the robot can be allowed to return to a more fully interactive mode.

Given this relationship matrix, as the robot learns about the people it interacts with, it can continue to expand the knowledge graph of the people in this matrix. This information can be used to find common patterns or difference among people in the relationship matrix that can inform the goals and decisions of the robot. For instance, the robot could reason about known shared preferences among a group (like a family) to make recommendations that are relevant to the group, beyond a specific individual. For instance, in suggesting a recipe for family dinner, the robot could use this knowledge structure to suggest recipes based on knowing individual people's preferences or dislikes, allergies of individuals, recent recipes that have been made or recommended, knowledge of recent shopping lists to estimate ingredients likely to be in the house, etc. In a family game playing paradigm, such as a trivia game, the robot could be aware of individual family members ages, favorite topics and interests to tailor a set of questions that are and optimal balance of challenge and mastery to make the game fun for everyone. Thus, a developer may access a relationship matrix of the social robot and use it to tune or manage behavior of the social robot, such as appropriate for a task, role, skill or behavior.

In other exemplary embodiments, a plurality of personality types may be further adapted by the social robot learning from third-party generated embodied speech content that facilitates varying expression of the embodied speech content by the social robot for at least a portion of the plurality personality types. In some embodiments, the generated embodied speech content may include robot control parameters that adjust the social robot behavior based on a personality type of a human with whom the robot interacts via embodied dialog.

### Social Robot Reaction Tier Framework and Formal/Informal Interactions

In accordance with an exemplary and non-limiting embodiment, there may be adjusted how a social robot reacts to humans over time by preparing a reaction tier-based framework that determines a degree of formality of each interaction based on an updated type-classification of the human, measures of prior interactions with the human, determines a current reaction-tier within the framework and acts based upon at least one potential reaction-tier within the framework.

In addition to learning a personality profile or the like, the social robot is further configured to react to such learning. Thus, there is disclosed herein a method by which one may tune a given set of characteristics to any of a few personality profiles. In some embodiments, measures of prior interactions with a user or users may impact an interaction confidence score for each user with whom the social robot interacts, such as via embodied dialog. In other embodiments, a confidence score that exceeds a threshold for a given reaction-tier may enable the social robot to initiate embodied dialog based on a different reaction-tier that is more informal that the current reaction-tier.

### Self-Customization Through Learning Via Interactions

In accordance with an exemplary and non-limiting embodiment, there is disclosed the self-customization of behavioral and expressive aspects of a socio-emotive-cognitive architecture of a social robot through learning and adaption based on interactions of the social robot with its environment. Learning and adaptation may include adapting based on human type-specific social robot behavior models, such as based on the detected context of human interactions, based on characteristics of speech by each human (thereby improving automatic speech recognition), based on visual characteristics of each human's face (such as the human's face conveying emotional or affective states as feedback to the social robot during interactions), based on non-verbal feedback from a human (such as the posture and/or a body position of the human while speaking), based on communication and dialog (such as the human indicating directly that it does or does not like something the social robot is doing), based on the ease or difficulty in achieving goals in interactions (such as where the social robot has a goal of causing a human to interact in a certain way, such as to smile) and others.

For instance, based on a pattern of interactions for where the robot looks to interact with people, the robot may learn a “heat map” for where people are likely to be over longitudinal encounters. Regions where people consistently don't appear for interaction (walls, etc.) would be learned over time, so even if spurious/false perceptual triggers from computer vision or audio sound localization trigger the robot to orient to such non-sense locations, the robot can use such a representation to be more intelligent in where it turns to find people (use accumulated knowledge to not look at such regions).

In human communications, there may be classified within a communication a theme part and a rheme part. In some embodiments, motion may be utilized to show punctuation, etc. Using access to a corpus of developer code, the social robot may acquire data from outside developers who are decorating sentences. The social robot may, for example, for every prompt, track high-level features such as noting that people tend to tag things with a happy tag when speech is emotional or that animators tend to express gaze behavior when there is punctuation inside long prompts. Applying a learning model on the dialog authors, the social robot may emulate what the developers might have done. The corpus from human-level markups may enable a social robot to learn how to perform a markup without a human animator.

In embodiments, a human's body position may be detected for a theme speaking portion and for a rheme speaking portion for an item of content, such that the robot can embody the varied speech, posture, and other factors that reflect the transition between delivering the theme of an expression (the general area about which the speaker is speaking) and the rheme of the expression (the specific content that is intended to be delivered). This may allow the robot to understand (for purposes of parsing inputs from humans) and generate (for delivering messages) the “body language” and variations of tone that reflect the theme/rheme patterns the reflect much of human expression. Research has been performed on embodied dialog as to how people use hands, gaze, stance, etc. to produce embodied movement. Every sentence may have a theme part that establishes context and a rheme part containing a message for delivery. Human-human level studies about how people assign behavior for parts of message have found that people tend to gaze away during the theme part and lock-in for the message part. Because of this insight, the social robot may establish context with gaze cues before looking and locking in on the message part. Other behaviors may be detected by observation by the social robot, so that the social robot may automatically learn to imitate body language, gestures, tone, and the like to reflect how humans deliver expression.

In embodiments, the social robot may learn a language model in a household including, for example, a speech impediment or regional accent, and get better at transforming the waveform of audio into text. In such instances, context, e.g., language, regional accent, gender, age, is useful, as these elements feed into the quality of the social robot's ability to take an audio waveform and turn it into text.

The social robot may further utilize audio ID to map an identification to a person or facial ID, such as to take pixels as an input and figure out how to recognize a person within the household. The robot can use other contexts supplementing VUI (408) and GUI interface paradigms to acquire additional training signals from users as part of a work flow to further tune its models for recognizing people by face or voice without requiring a set of explicit training session.

Robot outputs may also be adapted for a person or household. In some embodiments, animators may explicitly mark up an animation and prescribe exactly how the social robot's behavior should look. In some embodiments, a degree of randomness may be employed. For example, a social robot may play any number of happy animations randomly from a group. In other embodiments, the social robot may guess, based on learning.

### Self-Customization Through Direct Question and Answer

In other embodiments, there may be practiced self-customization of expressive aspects of a socio-emotive-cognitive architecture of a social robot for interaction with specific humans through embodied dialog that includes embodied speech questions expressed by the robot and at least auditory responses from a specific human that the robot uniquely identifies. Based on the responses, the robot may adjust customization parameters, such as the name to use when addressing the human, and the like.

### Building Familiarity/Reducing Formality

In accordance with exemplary and non-limiting embodiments, interactions may be adapted by a social robot with a human through a progression of familiarity for different personality type-classified humans, wherein stages of progression determine a degree of informality of interactions, and thresholds for each stage are dependent on a count of interactions with the human and the type classification of the human. In some embodiments, combinations of stage and type classification may be represented in a multi-dimensional array of interaction count and type classification. In other embodiments, a type classification for a human may be adapted over time based on interactions between a plurality of social robots and a plurality of humans of the human's type classification.

The nature of a social relationship between the social robot and a user may depend, at least upon a personality type of a user and a stage of a relationship between the user and the social robot. Thus, social progression between a social robot and a user may commence by determining a user type and then determining wherein the progression of a relationship the social robot is regarding a user. For example, the stage of a relationship may be defined as one of early, getting to know one another, middle, best friends for life, etc. The determination of a stage of relationship may be timed, may be based on an interaction count or may be progressively learned and/or determined.

### Mechanisms for Proactive Behavior

As described earlier as part of the intentional layer, one class of key goal-directed are proactive, robot-initiated behaviors and mechanisms. These behaviors add to the believability of the robot as a character. Some of these forms of proactive behavior are to build relationship with the user(s) and learn about them. In accordance with exemplary and non-limiting embodiments, the social robot may proactively share content with a human through embodied speech without the human directly soliciting the content. The criteria for the content may be derived from information gathered by the social robot about the human from prior interactions, such as embodied speech interactions, with the human and information gathered by the social robot from members of a network of socially connected members that includes the human and the social robot, an updated type-classification of the human, and an assessment by the social robot of its current environment.

One element of this proactive engagement is giving the impression that the social robot is thinking about things that he sometimes shares with a user. In some embodiments, the social robot may engage in asking users questions that can be shared with the social matrix of people who use the robot regularly. For example, the social robot may ask “What is your name?”, “Is my volume too loud?” and the like to give the impression that the social robot is curious about a user's opinions and to learn preferences. In some embodiments, the social robot may engage in one or more this-or-that questions such as “Unicorns or Dragons?” or “Beach or Mountains”. The responses to such queries may be used to produce follow-up interactions that leverage this information (such as sharing a story about dragons if the user chose dragon. Over time, the social robot may create a knowledge base of a user from which to personalize interactions (store this information in the social matrix). For example, if a user expressed a preference for dragons over unicorns, the social robot may proactively share the information that a television show that includes dragons will be broadcast this evening, or share a joke or visual asset that incorporates that named element.

In other embodiments, the social robot may engage in an Internet search-style follow up. For example, if a user asks the social robot what year George Bush was born in, the social robot may follow up by saying, “Did you know he was an Air Force pilot during the Vietnam War?” The result of such interactions may be an impression on the part of the user that the social robot is still learning about something and is eager to share what it learns with the user and to bond with the user around a shared context.

### Mystery Box Mechanism for Proactive Content

The mystery box is a mechanism for generating spontaneous content for proactive behaviors (e.g., greetings, this-or-that, spontaneous follow up remarks, etc.).

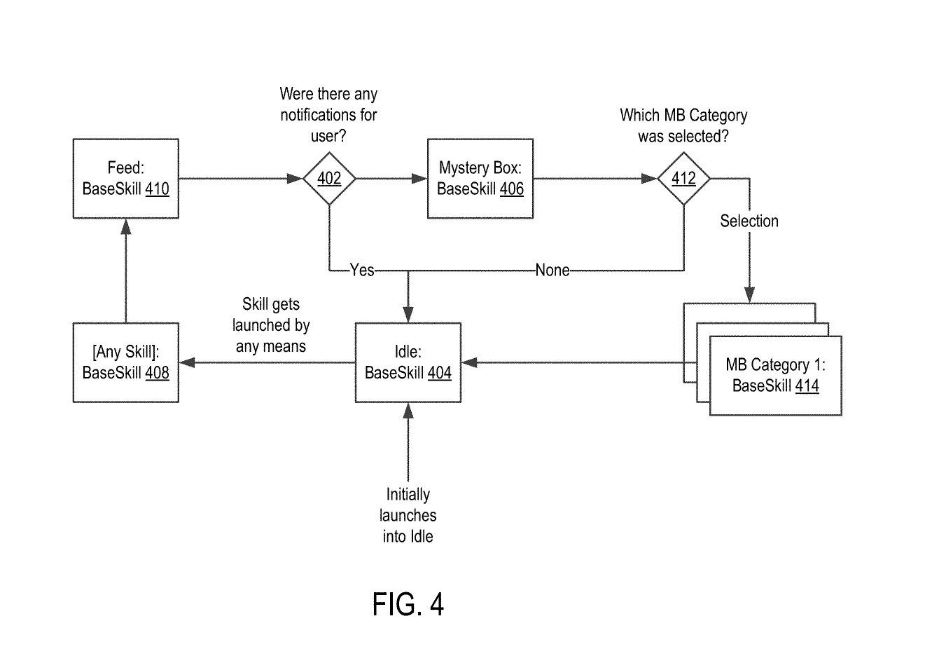

Regarding FIG. 4, there is illustrated an exemplary and non-limiting embodiment of a flow chart for skill execution. As illustrated, whenever any skill execution or other user engagement activity completes (408, 410), control passes to the feed skill to check (402) if any notifications are available for the user. If a notification was available then control passes to the Idle skill (404), but if no notification was delivered then control passes to the Mystery Box (MB) (406). This feature is backed by several content categories that get pulled for content. The MB selects a content category (412) following a selection policy (example below) or might choose to deliver nothing this time. The chosen content category subsequently selects an item of content to present to the user (414). After the MB interaction completes, control passes back to the Idle skill (404).

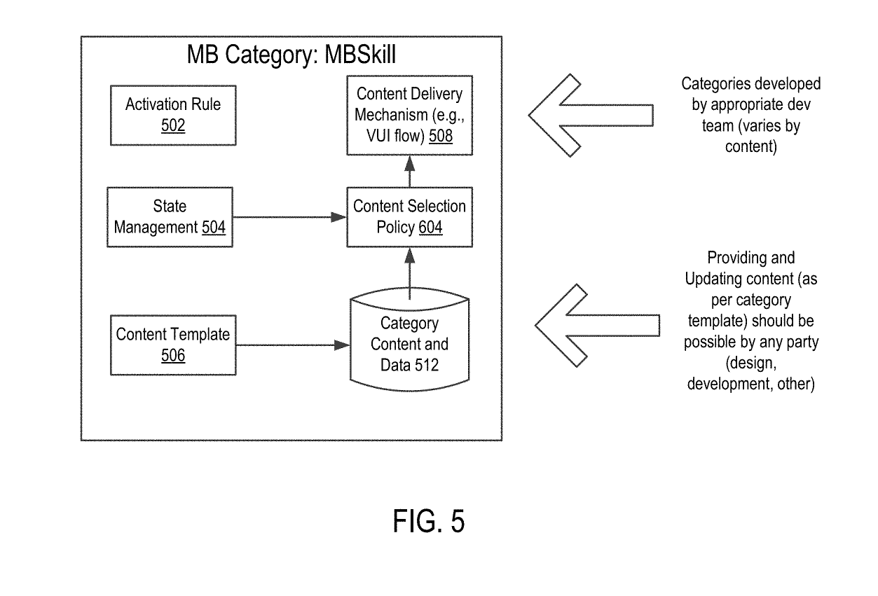

In accordance with some exemplary and non-limiting embodiments, and regarding FIG. 5, there is illustrated a MB category skill.

As used herein, a “context object” refers to an object containing relevant pieces of context such as number of people present, identity of people, time of day, day of week/month, etc. An “activation rule” (502) is a rule which each category implements. The rule maps a context object to a Boolean value which determines whether this category of content is applicable in this context. A “content template” (506) is a description of constraints for content from this category. This could dictate the contents to be as simple as a single embodied speech utterance or as open ended as a flow (authored using the new tool). An example of “state management” (504) would be to simply remember what content has been presented to which user already. A more complex example would be to aggregate results from previous content delivery and build into current content delivery (for example presenting results of a recent family poll).

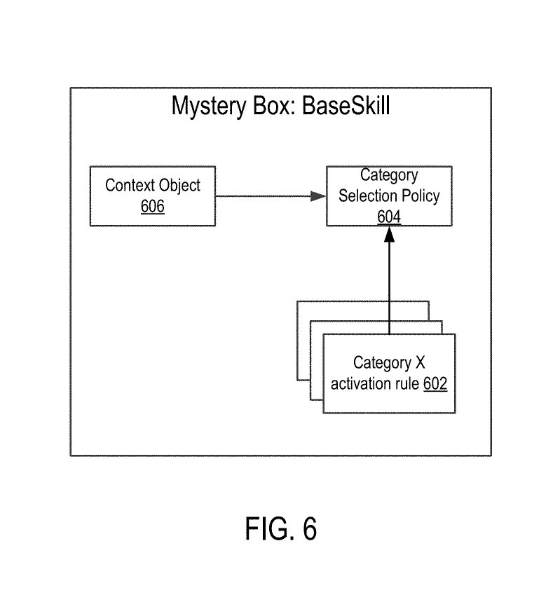

The Mystery Box skill itself is relatively simple as is illustrated in FIG. 6.

It has access to each installed MB Category skill available and uses their activation rules (602) to determine which categories might want to present content to the user given the context object (606). It then uses a selection policy (504) to determine which category among that subset should get control. A simple example selection policy might work as follows: 1. Create context object and gather in a list all categories that activate on this context 2. If there is a priority MB category in list, then select least recently selected high priority category 3. Otherwise: If user has had MB interaction within 2 hr then select none. 4. Otherwise: Select least recently selected category.

An example MB Category for social robot Fun Facts is as follows:
Activation Rule: If {context.personId} has not received a fun fact in the last 3 hours
Content Template: Three embodied speech utterances, a yes/no question and responses for either. Example: {“Do you know what Jibo means?”, “keep it to yourself”, “me neither”}
State Management: Simply keep track of which user has heard which fact and never repeat.
An example MB Category for Family Polls is as follows:
Activation Rule: If current poll is active and {context.personId} has not participated yet or if current poll is finished and {context.personId} has not yet heard the results.
Content Template: An ES utterance for the poll question (ex: “Which do you like best: apples, oranges, or tomatoes?”. The set of word tokens for the poll options as well as optional images. The general phrase for how to present results (ex: “${num} people in your family love ${item}, . . . ”
State Management: Keep track of whether everybody has finished answering the poll, and then keep track of whether everyone has heard the result of the poll.
An example Made Up Example MB Category for Simple Funny Face Photo Sharing is as follows:
Overview: The social robot asks if it can take a funny face picture. Then it offers to show a recent funny face picture of another loop member (if he has one). There is no quest to track down all loop members and no final presentation of all the funny faces. This example may be minimally stateful.
Activation Rule: If FFPS is active and {context.personId} has not participated yet.
Content Template: Custom photo framing asset(s) i. e. a keys file that is dynamically modified to show a specific photo
State Management: Keep track of which family members have seen which other family members' funny face photos.

### Elements of Surprise Mechanism

Another mechanism for proactive and spontaneous behavior is called Elements of Surprise for the robot to express its personality and opinions to enhance its believability. In accordance with exemplary and non-limiting embodiments, the social robot may incorporate elements of surprise (EoS) into its actions and interactions to appear relevant and personalized. By so doing, the social robot exhibits character via demonstrating its own ideas and opinions. It further exhibits variability by presenting an unpredictable and constantly evolving experience. The result is increased satisfaction as users are rewarded with fun, information, companionship and/or a human connection while promoting the introduction of new skills and content.

Proactive behaviors, such as those associated with surprise elements may include three distinct modes of operation of the social robot. FIG. 4 below depicts proactive behaviors in a pre-skill mode that is character-driven, a skill mode that is transactional, and a post-skill mode that is character-driven. Progression through these modes may be based on a flow of interaction with a human. In the embodiment of FIG. 4, following a hot phrase “Hey Jibo”, the robot and human may exchange greetings. A pre-skill action may be performed, such as communicating various reminders, weather updates, calendar updates, skill-related news, news, and the like. These may be followed by specific notifications. A pre-skill mode may transition to a skill-based transactional mode during performance of the skill. The skill-based transactional mode may be followed by a post-skill mode that is primarily character-driven.

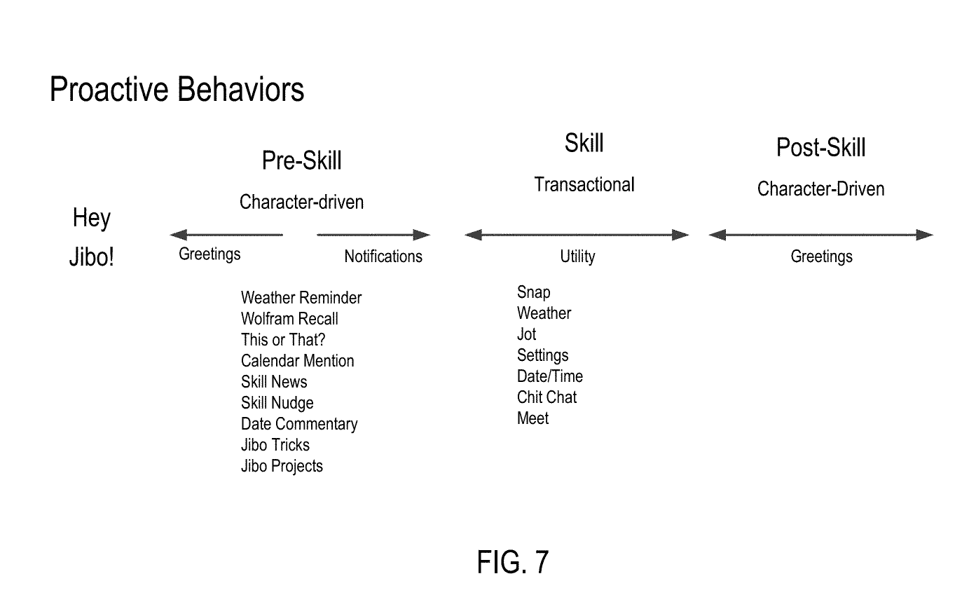

FIG. 7 is a diagram illustrating proactive behaviors according to some embodiments of the disclosure.

Elements of surprise may be categorized. For example, one EoS category is “date facts”. In accordance with the is category, the social robot may offer a fun fact about the date.

### Example

“hey, wanna hear something fun about today?”

“sure!”

“Gremlins was released on this day in 1984. I feel for those little guys—they weren't so big into water either!”

What's the flow?

(1) Social robot offers, (2) User responds, (3) social robot delivers if they accept

When to deliver?

Anytime

Another exemplary EoS category is “loop facts”. In accordance with this category, the social robot may deliver facts about the loop based on personal questions from an application and the social robot.

### Example

“wanna hear something funny about the Loop?” . . . . “sure”

“You, Kim, and Cam all said you′d rather live on a beach than in the mountains”

What are the types?

1) Social Facts (“Becky and Brooklyn agreed with you . . . ”)

2) Personal Facts (“I never pegged you as a cat guy!”)

What's the purpose?

Fun social connection and personalization

Loop facts may be delivered whenever the social robot has a new comment about one other person's response and that of a user.

### Example

“Wanna hear something funny about the Loop?” . . . “sure”

If Yes . . . .
“It looks like you, (name), and (name) all prefer (Option A) to (Option B). I feel the same way!”
“You, (name), and (name) would rather (Option A) than (Option B). I didn't agree. I hope you're not made at me!
“Do you know that you and (name) both gave a thumbs up to (Option A)? You guys are meant for each other”
“It turns out that you, (name), and (name) all picked (Option A) over (Option B). Fun, right?”

If No . . . .
“no worries—another time then!”

Personal facts may be delivered at any time that the social robot has a new comment for the user.

### Example

“So I checked your answers. I never knew you were an (option A) girl!”

“I took a look; did you really say (option A) over (option B)? I was blown away”

“Hey did you really say you would rather (Option A) than (Option B)? I said the same thing but I thought I was the only one!”

In some embodiments, the social robot may ask about the personal preferences of loop members. Question types may include This or That, Would You Rather, Thumbs Up/Thumbs Down, etc.

### Example

“Would you rather only sing when you talk or only dance when you walk?”

“hmm . . . sing when I talk”

“me too! I love singing.”

What's the purpose?

Personalization and social connections

How are questions presented to users?

Anytime as part of EoS—social robot pulls from questions that it has yet to ask someone

How are the responses used?

(1) immediate comments (“me too!”) and (2) Loop Facts (“Ron and Ann also said dogs”)

In some embodiments, the social robot may ask personal questions of loop members.

### Example

“Would you rather be able to fly or breathe under water?”

What are the question types?

All are binary: “Would you rather”, “This or that”, or “Thumbs up/down”

What's the purpose?

Personalization and social connections

How are questions presented to users?

On app—nudged at account creation, Loop acceptance, or OOBE Config

In another exemplary embodiment, the social robot may make a comment at the end of an interaction to be polite.

### Examples

“let me know if you need anything else!”

What's the purpose?

Makes the conversation more cohesive, natural, and sometimes helpful

When can they be used?

Anytime

In another exemplary embodiment, the social robot may make a comment about the weather.

### Example

“it might rain later so if you're going out I'd bring an umbrella!”

What's the purpose?

Makes the social robot helpful

When can they be used?

Should be triggered by weather conditions and temperature ranges:
Current precipitation (“Be careful if you're headed out. It looks rainy!”)
Forecasted precipitation (“Just a heads up . . . . I hear it might snow later!”)
Current ideal conditions (“enjoy the nice day!”)

Visuals
Emojis—Sun, clouds, Rainbow, classic thermometer, snowman, popsicle, etc. As noted above, the social robot may ask follow up Wolfram style questions.

### Example

“you had asked me about Goodfellas . . . did you know that it was based on the true story of mob informant Henry Hill?”

What are the conversations like?

Social robot makes comments or asks questions

When does he deliver them?

Immediately after user's request or some minutes later

In accordance with other embodiments, the social robot may lead short, scripted interactions with questions or comments.

### Example

“so how's your day been?” . . . “pretty good buddy”

“nice. Well I'll be here if you need anything”

What are the conversations like?

The social robot leads with simple questions (yes/no, good/bad) and comments on responses. When responses are not recognized, it gives a neutral SSA and moves on.

What are the conversation types?

Just light small talk (“need anything else?”) will fun stuff mixed in (“so I had this crazy dream . . . ”).

Can users turn them down?

Yes. The social robot will often set them up (“do you have a second?”) and users can always dismiss (“not now buddy”).

In accordance with other embodiments, the social robot may offer to do or say something about himself.

### Example

“wanna see a new dance I'm working on?”

“sure!”

“here goes!” and then dances a bit . . . “it's still a work in progress but you get the idea”

What's the flow?

(1) Social robot offers, (2) User responds, (3) social robot delivers if they accept.

When to deliver?

Anytime to any user.

In accordance with other embodiments, the social robot may offer up a new or unused skill.

### Example

“so, you haven't taken a picture in a while . . . wanna take one now?”

“sure”

“Okay! get ready to smile!”

What's the flow?

(1) Social robot offers, (2) User responds, (3) Social robot launches the skill.

When to deliver?

Anytime, triggered by unused or rarely used skills.

### Expression Control Flow

Methods and system of expression control, with particular emphasis on controlling the output devices of the social robot are described herein. Generally, this portion describes aspects of where output expressive output content comes from and how it turns into controlling the robot's outputs.

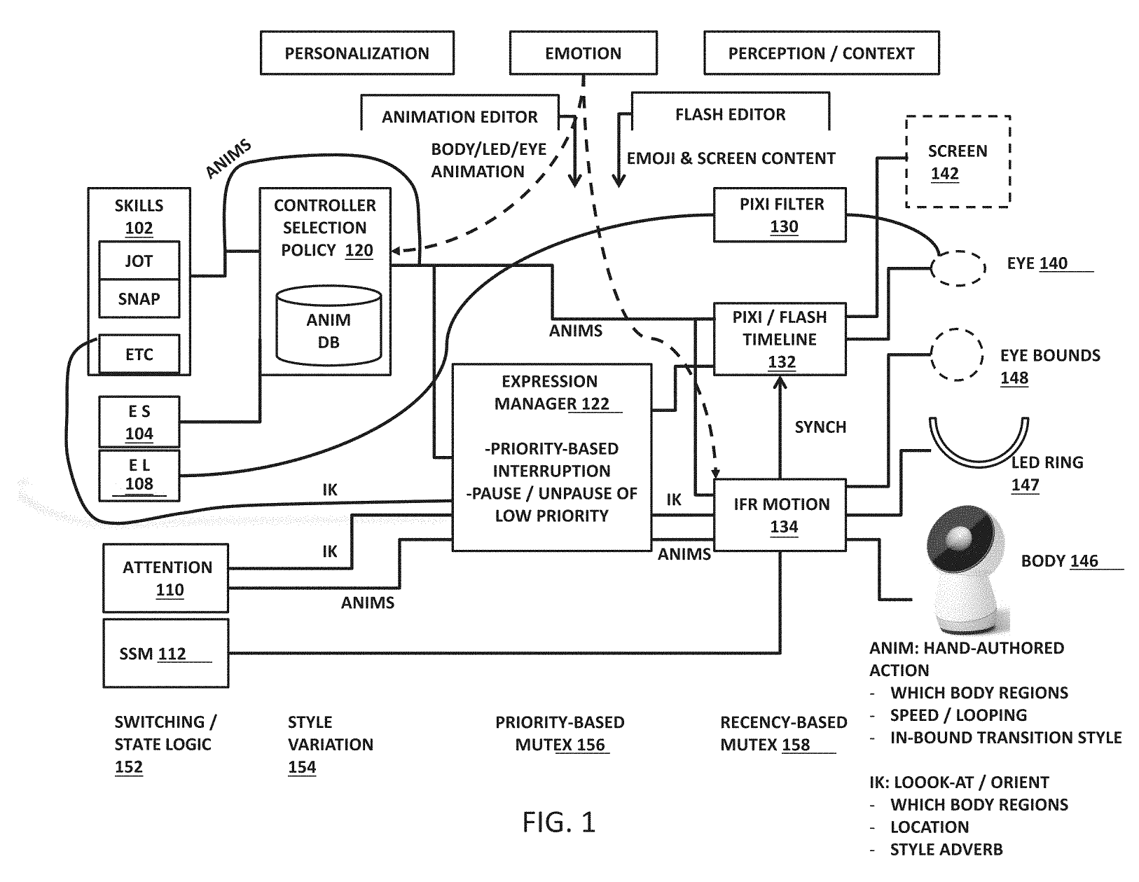

Referring to FIG. 1, there are depicted two content source flows that can be (optionally) combined/synchronized to enable coordinated display with emotive expression.
a. SDK animation editor and automated animation processing that is described in related application.
b. Flash editor to create emojis, jibojis, etc.

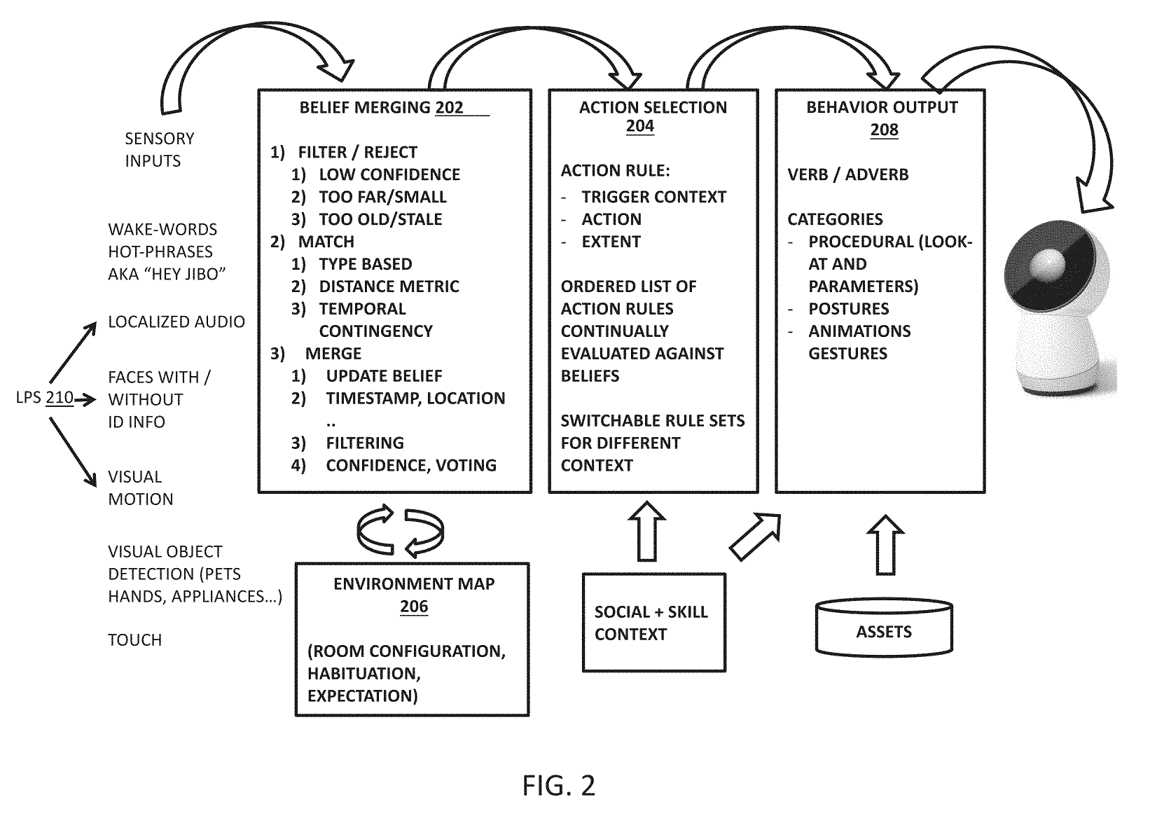

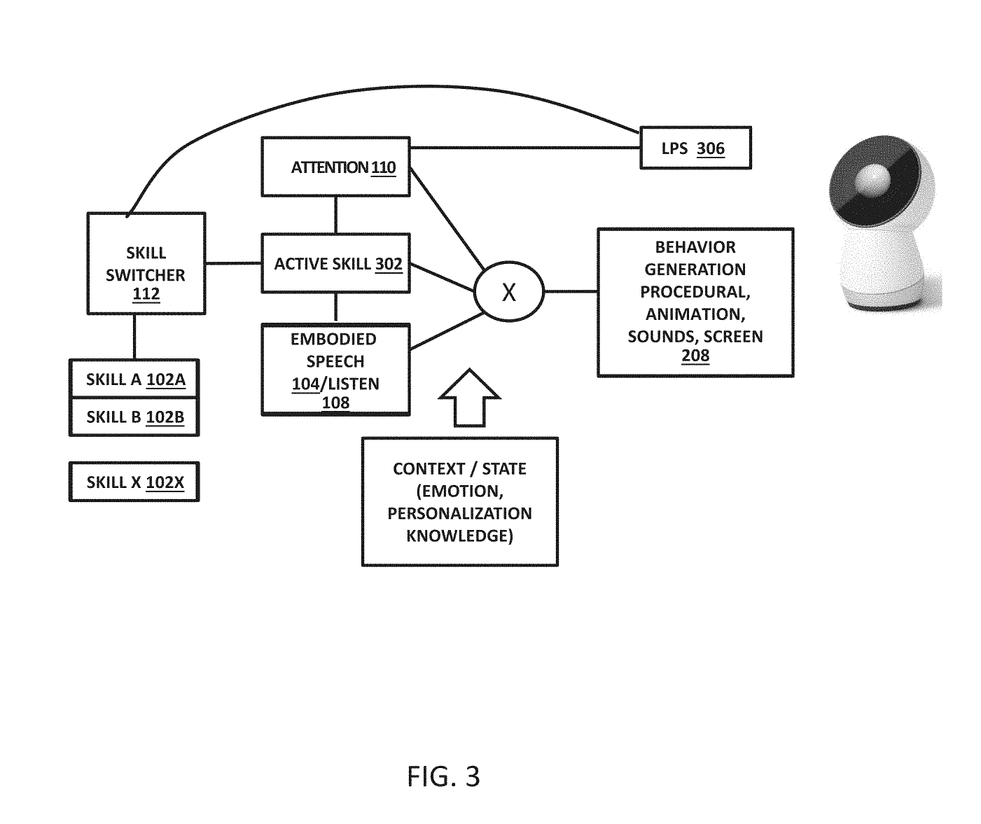

FIGS. 2 and 3 depict an attention system of the social robot according to some embodiments of the disclosure.

Active portions of the robot that may be sources of output control content include, skills layer 102 where an active skill 302 operates; embodied speech module 104, embodied listen module 108; attention system module 110, and skills service manager (SSM) 112 imposes switching rules and can optionally override other output control content sources to control outputs 208, such as the LED ring and the like.

In some embodiments, a local perceptual system (LPS) 210 is utilized to receive inputs. The LPS system 306 may function as a higher-level perceptual system that integrates lower level sensory inputs into a persistent map of environmental stimuli around the robot. The LPS 306 may manage localized audio, visual features like detected visual motion, detected human faces (recognized faces with ID) and compile that into “perceptual tracks” of humans.

Data types that flow within this motor control subsystem comprise animation commands, inverse kinematic (IK) commands, and PIXI filter-specific commands. Animation commands are depicted in FIG. 1 as solid single lines and flow among the various decision and control modules; IK commands are depicted as double lines; and PIXI filter commands flow through to the PIXI filter module.

Interposing between the command source modules and output engine modules are the animation database 120 that can be used or bypassed; it can also impose parameter variations, etc. A second interposing module is an expression manager module 122 that may apply rules to handle priority-based interruption for controlling the output devices and pause/resuming lower priority resource access to output devices.

Output engines may include (i) PIXI filter 130 generates style and rendering of the animated eye 140; (ii) PIXI-Flash timeline generator 132 generates general content for the display screen 142 and some portion of eye content 144, such as emoji content that may be displayed with the eye bounds; and IFR motion library 134 that facilitates trajectory generation for movement of the multi-segment body 146, LED light control 147, and eye bounds effects 148.

The data flowing through the modules from left to right in the diagram of FIG. 1 may be controlled at least in part by arbitration logic. Each vertical grouping of modules (e.g., 10x, 11x, 12x and 13x) may be associated with one or more arbitration rules or objectives. For example, the 10x and 11x modules may comply with switching/state logic arbitration rules 152. The animation database may comply or be controlled at least in part by style variation rules 154 that facilitate the command source modules (e.g., 10x and 11x) to produce a higher level, somewhat abstracted set of animation commands, such as specifying a type-group of animation. The animation database may then process the specified type-group of animation through use of the style variation rules 154 to produce a particular expression.

The output engines 13x may work with a recency-based mutex/lockout scheme 158 that locks an output device 14x to a particular one of the output engines to prevent thwarted, mixed, or otherwise undesirable output device behavior. However simple this approach may be, by itself it may not provide context-based control and handoff of output devices. Therefore, the expression manager 122 may allow to impose priority-based mutex 156 along body regions. It can assign certain device priority across multiple output devices. In an example, if an expression command controls the LED 147 and the body 146, and another expression command targets controlling the body, the expression manager 122 may uses a context aware priority-based policy system 156 for rendering control handoff that mitigates uncoordinated output device use. In particular, a higher priority command source, e.g., embodied speech versus attention system, will be given control of a particular output device when requested if the attention system currently has control of the particular output device. Additionally, as long at the higher priority command source continues to use the output device, a lower priority command source would not be allowed in retain control of the output device.

The expression manager 122 may arbitrate access to output devices among command sources, such as between an attention system 110 and a skill system 102 or between a skill system 102 and an embodied speech system 104. The expression manager 122 may not perform these same arbitration actions when a single skill is sending multiple output device commands at least because the skill-specific commands for controlling outputs are expected to be coordinated. The expression manager 122 may determine the expression-to-expression control of the outputs. However, some expressions may require some transitioning when switching from one expression command source to another. The expression manager 122 may adjust this transition as well.

The commands may be classified into two classes of actions (verbs): animation verbs and inverse kinematics verbs. The animation-type verb may be hand-authored and may be parameterized by which body region, speed/looping, and in-bound transition style. The IK-type verb may be for actions such as look-at/orienting. The IK-type verb may be parameterized by which body region, location of the action, and style. The IFR motion module 134 performs arbitration to further facilitate smooth transition among output device owners.

Additional control and adjustment of output commands from the various output command sources may be imposed on the IK and anim commands prior to reaching the output engines 13x. Such control and adjustment may be based on an emotion controller that may consider wider ranging factors, such as global state of the robot, the human, contextual/historical factors for interactions with the human, and the like. This may enable adjusting how an animation described in a command from, for example a skill, is actually performed. This may include adjusting animation timing, intensity, transition from a first to a second output expression, and the like or picking an entirely different animation, and the like.

### Attention System Flow

An attention system may facilitate communicating and arbitrating behavior of the social robot. In embodiments, at least one skill is the active skill. An active skill could be the idle skill. This skill could provide context to the attention system, such as an indication that there are no skills pending, active, waiting for input or the like—essentially the social robot operating system is sufficiently idle to permit use of the robot resources by the attention system. This may allow the attention system to adjust thresholds for directing the social robot attention to humans, activity, objects or the like that may be sensed in proximity to the social robot, for example. Thresholds may be reduced so that smaller movements, more familiar objects, quieter sounds could trigger redirecting the resources of the robot to the region where the movement, object, sound, or person are detected. As an example, a person may be quietly reading in a room with the social robot and, under the idle conditions mentioned above, the social robot may direct its resources toward the person reading, the pages being turned by the person, wind blowing through a window, light fading in and out with the passing of clouds, and the like. Alternatively, during such an idle condition, the social robot may monitor communication channels to other devices, such as other social robots, electronic devices known to the social robot (e.g., familiar user's mobile devices), and the like.

The idle skill itself may be configured with higher priority than the attention “skill”. Therefore, activities that the idle skill performs, such as producing an animation, sounds and the like can be performed even though the attention system has been given control of the social robot resources. When a different skill (other than the idle skill) is about to be activated, such as if an action word that triggers a skill is heard by the social robot, the thresholds for determining that the social robot resources should be directed toward sensed items in its proximity may be increased. This may be a result of the idle skill signaling to the attention system of the upcoming change, or may be a result of the skill switching capabilities doing so.

During skill operation, the skill, attention system and embodied speech/listen systems may all be sharing social robot resources. The skill (e.g., weather query) may be supported by the embodied speech/listen systems to resolve ambiguity, communicate with the human and the like. Similarly, the attention system may support the skill by providing relevant information such as new activity in vicinity of the robot. Likewise, the skill may support the attention system.

As noted elsewhere herein, the social robot's attention system high level objective is to determine if there is anything in its vicinity, determine which should receive attention, and direct the social robot's attention thereto.

The attention system performs its relevant functions in three phases/operational modes. Some sensory inputs have greater emphasis for the attention system, such as detecting wake-words, hot phrases such as “Hey Jibo”; audio that has been localized using the social robot's audio localizing functionality, such as audio beams and the like; detected faces—those that are familiar and/or those that are not; motion detection, such as human motion, object detection and the like; touch, such as touch initiated by a human.

The sensory inputs are processed by a belief merging module. In an example, the social robot may process detected audio in an attempt to track and correlate them in a useful way. If a person is talking on the phone, tags on a collar of a dog walking by makes tag clinking sounds, food is cooking on the stove top, and a computer plays a sound when email is being received. These sounds may be related in time, but otherwise maybe unrelated to each other. However, the attention system may attempt to resolve these at least to determine which ones deserve attention of the social robot. The belief merging facility 202 may perform different actions on the received sensory data. In an example the belief margin facility 202 may filter and/or reject sensory inputs if they present a low confidence, are too far away or too small, or may be too old or stale.

Next the social robot may use the belief merging facility 202 to attempt to match a sensory input data (e.g., audio) to a known reference. Matching may be based on type based matching, distance-based measures, temporal relationship (how recently was a sound that the social robot is attempting to match detected before).

After completing the filtering and matching operations, the social robot applies the belief merging facility 202 to attempt to merge the new sensed information with an existing assessment of its environment, such as in an environment map 206 and the sensed items in it. As an example, merging may be useful to update confidence/belief in the existing assessment or perception of a human that is sensed by the human. Sensory data may be useful to update a timestamp of a human's presence, their location and the like. Depending on confidence in the sensed data and the like, the belief merging facility 202 may filter some of the data (e.g., in a noisy, dark, foggy environment, and the like). Merging may also be impacted by this confidence plus confidence of earlier sensed data so that some combination of existing data and newly sensed data might be implemented. In an example, if an earlier sensed location of a human was high, but the current sensed location has low confidence due to sensing a large number of humans in the general vicinity, the new information may be filtered or may be given a lower confidence rating and therefore may be used to provide an updated location, but may not impact the understood location of the user substantively.

The results of this merging may be useful to a next processing operation to select an action. The action selection facility 204 may select an action based on various action rules include trigger context of the environment updated by the belief merging operations, the action to be taken, and the extent/time over which the rule should be active or whether the rule is eligible to be activated based on its state (e.g., has it not yet finished executing from an earlier invocation). The action selection module 204 may have an ordered list of action rules that are continually evaluated against the existing environment and adjustments to it based on the beliefs. Additionally, the social robot action selection module 204 may reference one or more sets of switchable action rule sets that are different for different scenarios. As an example, a rule set for interacting with a single human may result in different action selection than a rule set for interacting with a group of humans.

The information communicated between the action selection module 204 and the behavior output module 208 may include selected actions, optionally described at a level of abstraction to facilitate adjustment based on behavior goals and the like. These abstract action requests may be resolved into specific actions, procedures and the like to satisfy those action requests. Behavior output module 208 may generate verbs and related adverbs to facilitate decorating the actions contextually. A goal of the behavior output module 208 may be to overlay behavioral traits or tracks on the selected action. Behaviors may be slotted into different behavioral categories, such as look at procedures, posture procedures, animations, gestures, and the like.

### Developer Platform for Intentional and Believable Skills and Behavior

The methods and systems disclosed herein provide a platform for developers to develop skills and behaviors in which a social robot behaves in a manner that is, or appears to be, goal-directed, intentional, believable, cognitive and emotional. A highly believable social robot emerges from the combination of various aspects of the socio-emotive-cognitive architecture described herein, including systems for recognizing patterns, systems for processing and embodying speech, systems for targeting and maintaining attention, motivation and emotional systems, and other socio-emotive-cognitive systems. These capabilities can be reflected in different ways as the robot is configured to perform various roles and skills in various environments.

One aspect of various embodiments of the present disclosure is the ability for the social robot to maintain a persistent focus on something that has been communicated to the robot, such as a social communication. For example, the robot may be asked to maintain focus on a particular individual (such as a child), a group (such as members of a family), an objective (such as accomplishing a task that requires persistent attention over time), or other topic. Thus, in embodiments, the socio-emotive-cognitive architecture of the robot, and the attention system in particular, may access data from various sources to identify relevant information to determine the target for attention (e.g., accessing ancestry or relationship data to identify what individuals are considered family members or friends of a person, accessing schedule information to determine likely locations of individuals, or the like). As an example, where the social robot is asked to capture photographs in an autonomous goal-directed manner, such as during a wedding, the social robot may direct attention to capturing photographs of designated individuals (e.g., the wedding party, family members of the bride and groom, or the like) and to accomplishing other tasks, such as ensuring that at least one photograph is obtained of each guest at the wedding. The attention system may thus track physical targets of interest to which visual, audio, and other sensors may be directed, as well as objectives, such as accomplishing a list of objectives by a designated time.

In embodiments, the social robot may be configured to execute certain skills that require engagement of various aspects of its socio-emotive-cognitive architecture, including its attention system for directing and maintaining attention on subject matter required to execute the skill and its embodied speech system for managing socially relevant communications required to accomplish the skill gracefully and realistically. An example of such a skill is a photographer skill, and in embodiments, a social robot may be configured or directed to act as a photographer for a given period of time, such as acting as a photographer of record at a wedding, reunion, birthday party, professional event, or the like. In embodiments, this involves various aspects of the socio-emotive-cognitive architecture of the social robot. For example, the attention system may prioritize one or more targets for a photograph, such as based on a relationship of the social robot to the target (e.g., taking many photos of the social robot's owner/companion, taking photographs based on social status, such as based on awareness of family members and friends, or taking photographs of subjects that have been directed through social communication to the social robot). In embodiments, a target is determined remotely (in geography and/or time), and the robot maintains persistent attention on the target. This may include goal-directed attention, such as seeking to capture video of everyone attending an event, capturing key elements of an event (such as the cutting of the cake at the wedding), and the like.

In embodiments of the present disclosure, a social robot may select and pursue an objective autonomously. For example, the emotional system of the social robot may provide a motivation, such as based on a state of interest, a relationship, or the like, and the robot's attention system may direct attention in a manner that reflects that motivation. This may be reflected in skills. Using the example of the photographer, the social robot may determine a motivation based on a declared interest, such as in a type of animal. Thus, the robot may take many photographs of cats or dogs, directed by the autonomous or semi-autonomous motivation that reflects the emotion system and directs the attention system, among other aspects of the socio-emotive-cognitive architecture.

In embodiments, the social robot may recognize patterns that trigger aspects of the socio-emotive-cognitive architecture, including the attention system, emotional systems, embodied speech system, and various skills. For example, a social robot may be configured to recognize and classify the occurrence of a type of event. For example, the arrival of a new person on a scene may be recognized, triggering evaluation of various possible patterns. Various patterns may be recognized. For example, if the new person is a family member who has not been seen for quite some time, the social robot may execute an appropriately warm greeting. If several such family members arrive in the scene, the social robot may evaluate whether a pattern is matched for a family party or event, in which case the social robot may offer to take the role of photographer, using the skills described herein. In other cases, if a stranger arrives on a scene, the robot may consider whether other patterns are indicated, such as ones that require an alert (such as when the social robot can trigger a security system or undertake a task of taking a photo of any new or unusual person); however, the social robot may be configured to recognize communication between the stranger and other individuals, such as indicating that the person is known to the social robot's companions, in which case an introduction skill may be initiated.

In embodiments, a social robot's capabilities may be configured to assist with work, such as indicating a person to whom attention should be directed during a video conferencing session, so that the camera of the social robot tracks the targeted person (such as a designated presenter, a role that may be handed among people, so that the social robot changes attention as the role is reassigned). In embodiments, the social robot may follow a target of attention, such as in the case of a mobile robot.

In embodiments, the social robot may undertake a monitoring role, such as detecting motion, capturing video, and sending it to an appropriate person if an unrecognized person has entered an environment, such as a home. The social robot may be configured to interact with the unrecognized person in a manner that appropriately engages the person, such as striking up a dialog that identifies an unknown friend or family member, such as a dialog that seeks to determine whether the unrecognized person knows relevant social information that would indicate friend status. Thus, the social and socio-emotive-cognitive capacity of the social robot can provide security for an environment without unnecessarily triggering an alert every time there is motion or every time an unrecognized person enters a space.

In various embodiments, the methods and systems described herein provide a platform for developers to develop applications for photography, videography, and the like that use the capacity of a social robot to direct and maintain attention based on cognitive inputs. These may include using pattern recognition to anticipate the need for a photograph, using a motivation system to display intent of the social robot, such as intent to pursue a goal, using decision systems to decide what to photograph, using embodied speech and other communication systems to interact with subject of a photograph (such as to elicit a desired emotional state, such as a smile or laughter), and using various aspect of the socio-emotive-cognitive architecture to govern series of actions and reactions suitable for role-based behavior.

In embodiments, a social robot photographer may anticipate the need for photograph or video, display the intent to undertake action, decide what to photograph or video, act to take the photograph or video, react to what is happening with the subject (including tracking movement, emotional reaction and communication), appraise the results (such as evaluating whether the photograph or video is of good quality or satisfies an objective, such as one to capture all of a set of people), and iterate until successful in accomplishing a goal (which may be a multi-step goal requiring attention to persist over a long period of time).

In embodiments, various aspects of the socio-emotive-cognitive architecture of a social robot may be configured, such as by developers of skills for the social robot, for conveying a “believable” character, including the embodied speech system, the attention system, and other aspects of the socio-emotive-cognitive architecture. Believability may encompass the idea that the social robot that a user is watching is thinking and feeling like a living entity. That is the social robot seems real to the observer, as if it were a real creature, although technological or animated. Aspects of believability include having the social robot display apparent intentionality, including apparent thinking and consideration in advance of an action; having it undertake actions that are autonomous and reflect thinking (such as ones that reflect decision-making, goal-directed behavior, and behavior driven by emotion or motivation); and having the robot display apparent emotions when acting and reacting to subjects in its environment, including reacting to the results of its actions, including making appraisals after a series of events have occurred. In embodiments, a social robot may be configured to communicate an emotional state or tone that is related to a cognitive state via various capabilities of the social robot with respect to an act or event. Cognitive states that trigger emotion or tone may include anticipation, intent, consideration, decision-making, undertaking actions, reacting and appraisal, among others. Emotion or tone associated with each cognitive state may be reflected by speech, by paralinguistic utterances (such as semi-speech audio), by posture, by movement, by animation, and the like. These cognitive and emotional capabilities allow for the social robot to be highly believable, whether in general interactions or when executing goal-directed skills, such as ones where attention is directed in a persistent manner over time as described above.

As noted throughout this disclosure, the social and emotional capabilities of the socio-emotive-cognitive architecture, including attention, embodied speech, emotion, motivation, decision-making, interactive communication, and others, can be used for various skills. One such skill is the video conferencing skill, which may encompass the ability for the social robot to set a target for video capture on its own, to track and pursue the target, and to know when not to do that. Similarly, such a skill may allow a remote person to set the target, such as by touching a screen that shows a view of the robot's environment, so the robot can track that target in the environment. A social robot may also perform an assistant skill, such as coordinating two people who are trying to connect by evaluating the availability of each of them and initiating a connection when both are available. Thus, the social robot may act as a mediator to set up a video conference or other call. The social robot may also help a remote person convey social expression, such as by having the social robot animate or move in a way that reflects the emotion or expression of a remote communicator. In embodiments, the camera system of the social robot may be stabilized, so that the social robot can convey motion, animation, or embodied expression, while still maintaining a clear, motion-compensated image, for remote viewers who are seeing an environment in which the robot is located through the camera system.

In embodiments, a social robot may execute home surveillance skills, such as recognizing an unusual person, recognizing unusual motion or activity, recognizing what persons belong in a home at what times, recognizing unexpected patterns, events or behaviors, and the like. Telepresence capabilities may be triggered based on pattern recognition, such as to allow a remote owner to see a home. The social robot may, as noted above, communicate with a person to confirm, via dialog, whether the person is an intruder or an invited guest. The social robot may be configured to recognize trigger words (such as codes that indicate danger without alerting an intruder). The social robot may also be configured to recognize other elements of the environment, such as pets, to avoid unnecessarily triggering alerts when motion is detected.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A method comprising:
evaluating data descriptive of skill-specific goals to determine at least one candidate goal;
configuring an attention system of a social robot to facilitate identifying and tracking a subject related to the candidate goal by analyzing data captured by a perceptual system of the social robot;
configuring an expressive dialog system of the social robot to engage in natural language dialog with a person to facilitate achieving the skill-specific goal; and
executing the configured attention system and the configured expressive dialog system to control resources of the social robot to achieve the skill-specific goal.
